(19) United States
(12) Patent Application Publication
(10) Pub. No.: US 2008/0180830 A1
(43) Pub. Date: Jul. 31, 2008

(54) EMERGENCY UNLOAD VERIFICATION DEVICE AND STORAGE APPARATUS

(75) Inventor: Shinji Miyamoto, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/018,466

(22) Filed: Jan. 23, 2008

(30) Foreign Application Priority Data
Jan. 30, 2007 (JP) 2007-20102

(51) Int. Cl. G11B 15/18

(52) U.S. Cl. 360/69

(57) ABSTRACT

An emergency unload verification device verifies whether or not a control unit to control an emergency unload operation in a storage apparatus is abnormal. A storage section stores previous waveform information of a control signal to be sent out by the control unit for controlling the emergency unload operation. A waveform comparing section compares a waveform information of a control signal, sent out by the control unit for controlling the emergency unload operation when the emergency unload operation is executed, with the waveform information stored into the storage section. An abnormality determining section determines whether or not the control circuit is abnormal on the basis of the comparison result of the waveform comparing section.

### BACKGROUND

1. Field

The disclosed technique relates to an emergency unload verification device and a storage apparatus which verify whether or not a driving section to send out a control signal for executing emergency unload is in an abnormal state. In particular, the technique relates to an emergency unload verification device and a storage apparatus which automatically verify whether or not a control circuit to execute emergency unload is in the abnormal state.

2. Description of the Related Art

A magnetic disk apparatus has generally been provided with the function of automatically unloading a head for preventing occurrence of a failure such as absorption in a case where power supply is shut off without undergoing a formal procedure, or some other cases. This function is called emergency unload.

For example, Japanese Laid-Open Patent Publication No. 59-79475 discloses a technique relating to a magnetic disk that executes emergency unload when a servo-system oscillation is detected. Further, Japanese Laid-Open Patent Publication No. 2005-71513 discloses a technique relating to a magnetic disk that executes emergency unload by the use of counter-electromotive force generated by inertia rotation of a spindle motor.

However, even with the use of the related techniques as described above, in a case where a control circuit to execute emergency unload itself is in the abnormal state, emergency unload might not be normally executed, to cause occurrence of a critical failure in the magnetic disk apparatus.

Therefore, in order to test the presence or absence of abnormality of the control circuit to execute emergency unload, a time-consuming operation of observing a waveform information outputted by a control circuit with the use of a measuring instrument before factory shipment has hitherto been generated. Further, there have been cases where, even when the control circuit is determined as normal in the test before factory shipment, a defect of the control circuit due to thermal stress or the like becomes obvious after the fact, thereby causing occurrence of a failure.

Accordingly, it is an object of the disclosed technique to provide an emergency unload verification device and storage apparatus which automatically verify whether or not a control circuit to execute emergency unload is in the abnormal state so as to prevent occurrence of a critical failure.

### SUMMARY

In keeping with one aspect of an embodiment of this technique, an emergency unload verification device, which verifies whether or not a control unit to control an emergency unload operation in a storage apparatus is abnormal, includes a storage section which stores previous waveform information of a control signal to be sent out by the control unit for controlling the emergency unload operation. A waveform comparing section compares a waveform information of a control signal, sent out by the control unit for controlling the emergency unload operation when executing the emergency unload operation is executed, with the waveform information stored in the storage section. An abnormality determining section determines whether or not the control circuit is abnormal on the basis of the comparison result of the waveform comparing section.

A storage apparatus including an emergency unload function includes a driving section which sends out a control signal for executing emergency unload, and an abnormality determining section which compares a waveform information of a control signal sent out from the driving section with a previously stored waveform information, to determine whether or not the driving section is abnormal.

An emergency unload verification method in which a storage apparatus verifies whether or not a driving section to send out a control signal for executing an emergency unload is in an abnormal state includes a recording step of recording into a storage section a waveform information of a control signal sent out from the driving section for executing emergency unload. A verifying step compares the waveform information recorded in the recording step with a previously stored waveform information, to verify whether or not the driving section is in the abnormal state.

### BRIEF DESCRIPTION OF THE DRAWINGS

The above and other objects, features, advantages and technical significance of this disclosed technique will be better understood by reading the following detailed description of presently preferred embodiment of the disclosed technique, when considered in connection with the accompanying drawings.

FIG. 1 is a diagram of a magnetic disk apparatus;

FIG. 2 is a diagram for explaining control of a VCM;

FIG. 3 is a graph showing an example of a normal voltage waveform information during an emergency unload operation;

FIG. 4A is a graph showing an example of an abnormal voltage waveform information during the emergency unload operation;

FIG. 4B is a graph showing an example of an abnormal voltage waveform information during the emergency unload operation;

FIG. 5 is a block diagram showing a configuration of a magnetic disk apparatus;

FIG. 6 is a graph showing an example of a clock signal created on the basis of a counter-electromotive voltage of an SPM;

FIG. 7 is a flowchart showing an operation at the time of power-off;

FIG. 8 is a flowchart showing an operation at the time of power-on; and

FIG. 9 is a block diagram showing another configuration of a magnetic disk apparatus.

### DETAILED DESCRIPTION OF THE EMBODIMENT

In the following, an embodiment of an emergency unload verification device and a storage apparatus according to the disclosed technique is detailed with reference to attached drawings.

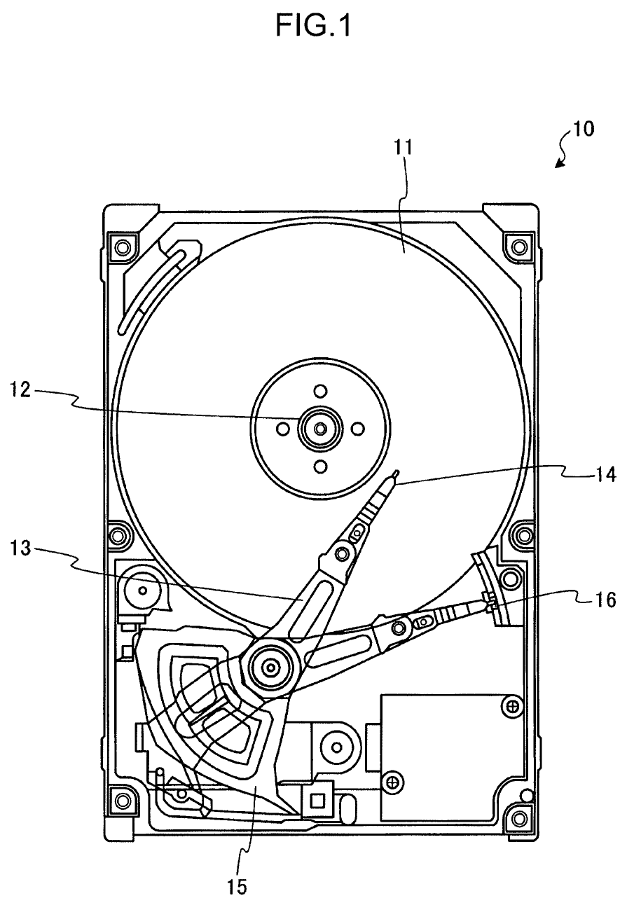

First, emergency unload is briefly described. FIG. 1 is a sectional view of a magnetic disk apparatus 10. In this figure, a magnetic disk (or disks) 11 is a storage medium that stores a variety of information, and is rotationally driven by a spindle motor (hereinafter referred to as “SPM”) 12.

Reading to and writing from the magnetic disks 11 is performed by heads 14 provided at one end of arms 13. The heads 14 execute reading and writing while being held in a slightly floating state above the surfaces of the magnetic disks 11 due to lift force generated by the rotation of the magnetic disks 11. Further, driven by a voice coil motor (hereinafter referred to as “VCM”) 15 provided at the other end of the arms 13, the heads 14 move in a seek direction, to change a track where reading and writing are performed.

A ramp 16 is a structure for holding the heads 14. When the heads 14 are above the magnetic disks 11 at the stopping of the magnetic disks 11, since lift force due to rotation is not generated, the heads 14 might come into contact with the magnetic disks 11 and be absorbed thereto. For avoiding this from happening, at the stopping of the magnetic disks 11, the magnetic disk apparatus 10 controls the VCM 15 so as to unload the heads 14 to the ramp 16.

Typically, unload of the heads 14 is executed on the basis of a command issued by a host such as a personal computer to which the magnetic disk apparatus 10 is connected. However, when the power of the host is suddenly and unexpectedly shut off for some reason, such a command is not issued. Therefore, when power from the host is shut off for some reason, the magnetic disk apparatus 10 automatically executes the operation of unloading the heads 14 to the ramp 16. This operation is called emergency unload.

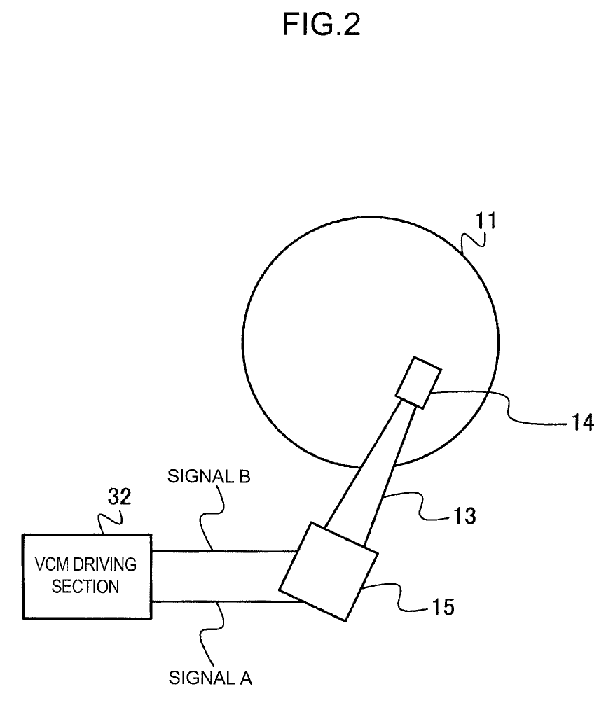

Next, control of the VCM 15 for executing emergency unload is described. FIG. 2 is a view for explaining control of the VCM 15. As shown in this figure, a VCM driving section 32 controls the VCM 15, using two signals: a signal A and a signal B.

When a voltage of the signal A is higher than a voltage of the signal B, the VCM 15 is controlled such that the heads 14 move in a direction toward the inner periphery of the magnetic disks 11. On the other hand, when the voltage of the signal B is higher than the voltage of the signal A, the VCM 15 is controlled such that the heads 14 move in a direction toward the outer periphery of the magnetic disks 11.

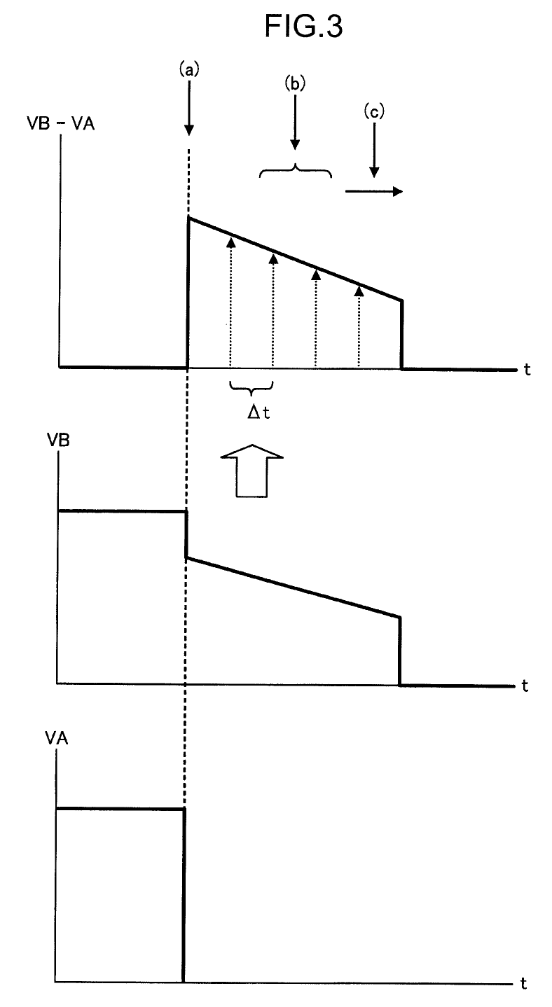

Therefore, in the case of executing emergency unload as the operation of moving the heads 14 to the ramp 16 which is located further outside of the outer periphery of the magnetic disks 11, the VCM driving section 32 sends out to the VCM 15 a waveform information where the voltage of the signal B is made higher than the voltage of the signal A, as shown in FIG. 3. In this figure, symbol (a) denotes a time point at which execution of emergency unload is started, symbol (b) denotes a time point at which the heads 14 complete moving to the ramp 16, and symbol (c) denotes a time point at which the heads 14 are secured on the ramp 16.

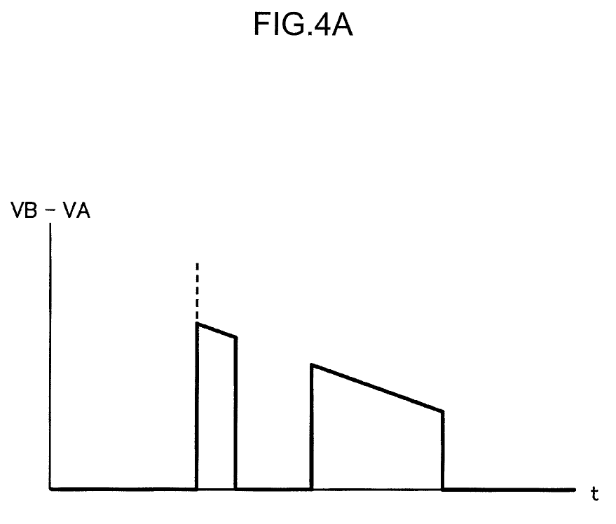

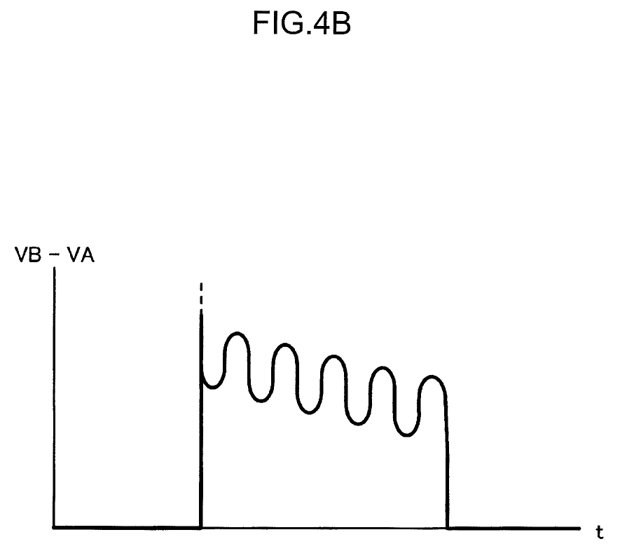

However, when the VCM driving section 32 is in an abnormal state, a voltage waveform information sent out at the time of executing emergency unload is, for example, one shown in FIG. 4A or 4B, with which emergency unload is not normally executed, thereby increasing the possibility of occurrence of a failure such as absorption.

Given this, the magnetic disk apparatus 10 previously stores a voltage waveform information in normal time as shown in FIG. 3, and compares the stored voltage waveform information with a voltage waveform information sent out by the VCM driving section 32 when the emergency unload is executed. When the voltage waveforms do not agree with each other, the VCM driving section 32 is determined as abnormal, and a necessary handling is executed. With this mechanism, it is possible to automatically verify the presence or absence of abnormality of the VCM driving section 32, so as to avoid occurrence of a critical failure in the magnetic disk apparatus 10.

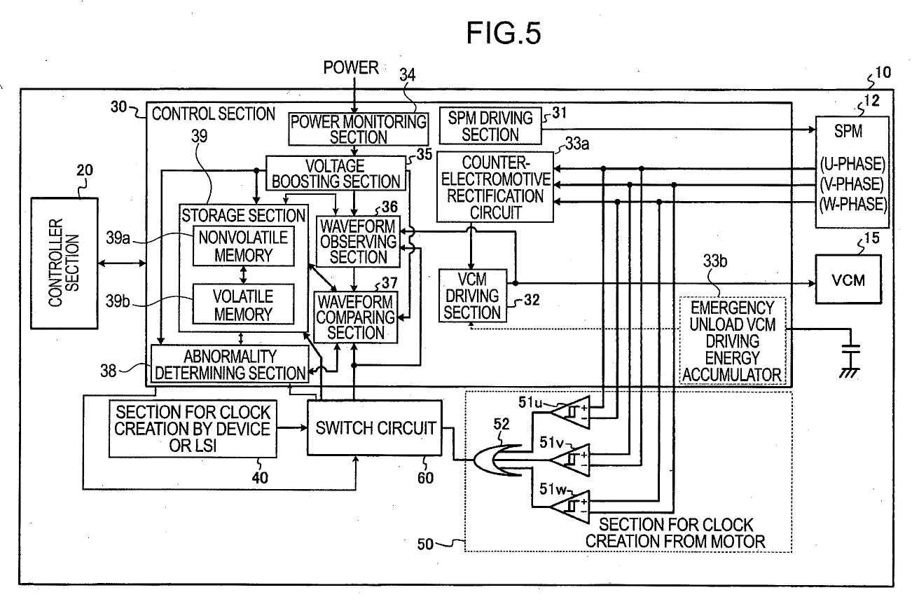

Next, the configuration of the magnetic disk apparatus 10 is described. FIG. 5 is a block diagram showing the configuration of the magnetic disk apparatus 10. In this figure, configurations not related to emergency unload are omitted for the sake of simplicity of explanation.

As shown in this figure, the magnetic disk apparatus 10 has a controller section 20 and a control section 30 in addition to the already described SPM 12 and VCM 15. The controller section 20 makes a request of the controller section 20 itself or the control section 30 for execution of a process in response to a variety of commands transmitted from the host. The control section 30 executes a process requested by the controller section 20, and also transmits an instruction to each section of the magnetic disk apparatus 10 to control a state of each section.

The control section 30 has: an SPM driving section 31; a VCM driving section 32; a counter-electromotive rectification circuit 33a or an emergency unload VCM driving energy accumulator 33b; a power monitoring section 34; a voltage boosting section 35; a waveform observing section 36; a waveform comparing section 37; an abnormality determining section 38; and a storage section 39. The control section 30 controls these sections. These sections are not necessarily provided inside the control section 30.

The SPM driving section 31 is a control section to control drive of the SPM 12. As already described, the VCM driving section 32 is a control section to control drive of the VCM 15, and outputs to the VCM 15 a control signal for controlling an emergency unload operation when the emergency unload is executed. Power, required for control of the emergency unload operation by the VCM driving section 32 when power supply to the magnetic disk apparatus 10 is shut off, is supplied by the counter-electromotive rectification circuit 33a that uses a counter-electromotive voltage of the SPM 12 or by the emergency unload VCM driving energy accumulator 33b that uses a previously stored voltage.

The power monitoring section 34 is a circuit to monitor power supply to the magnetic disk apparatus 10. When the power monitoring section 34 detects that power supply to the magnetic disk apparatus 10 has stopped, the control section 30 confirms whether or not the heads 14 have been unloaded to the ramp 16. When the heads 14 have not been unloaded, the control section 30 instructs the VCM driving section 32 to execute emergency unload, and also instructs the waveform observing section 36 to observe a waveform information of a control signal sent out by the VCM driving section 32.

The voltage boosting section 35 is a circuit to supply a boosting voltage such that the waveform observing section 36, the waveform comparing section 37, the abnormality determining section 38, the storage section 39 and the like are able to operate for a prescribed period of time even after stopping of power supply to the magnetic disk apparatus 10. The voltage boosting section 35 makes a voltage stored into a capacitor or the like during power supply, and supplies this previously stored voltage after stopping of power supply.

The waveform observing section 36 is a circuit to observe, by sampling, a waveform information of a control signal outputted by the VCM driving section 32 for controlling the emergency unload operation. Specifically, the waveform observing section 36 measures heights of a waveform information of a signal outputted from the VCM driving section 32 at prescribed intervals with the use of an A/D converter, and outputs the measurement result to the waveform comparing section 37.

The waveform comparing section 37 is a circuit to compare the measurement result obtained by the waveform observing section 36 with waveform information in normal time having been previously stored into the storage section 39. Specifically, the waveform comparing section 37 compares a height of the waveform at each time point measured by the waveform observing section 36 with a height of the normal waveform at the time point after the lapse of the same time period from the start of the emergency unload operation, and makes the comparison result at each time point stored into the storage section 39.

It should be noted that comparison of waveforms by the waveform comparing section 37 may be executed every time a measurement result at a certain point is outputted from the waveform observing section 36, or may be executed altogether after measurement results at all time points have been outputted from the waveform observing section 36.

Further, the height of the waveform at each time point measured by the waveform observing section 36 may be previously stored into the storage section 39, and when the magnetic disk apparatus 10 is activated next time, the waveform comparing section 37 may compare the previously stored waveform information with a waveform information when the emergency unload operation is executed. When emergency unload is executed at the time of power shut-off, power usable for operations of the waveform observing section 36 and the like is limited The abnormality determining section 38 is a circuit which applies the waveform comparison result, made to be stored into the storage section 39 by the waveform comparing section 37, to a prescribed discriminant, to determine whether or not the VCM driving section 32 is in the abnormal state. The determination result is stored into a nonvolatile memory 39a of the storage section 39. For example, the abnormality determining section 38 judges the waveform comparison result at each time point, namely compares a difference between a height of the waveform actually outputted and a height of the normal waveform with a prescribed threshold at each time point. When the difference is larger than the threshold at any one time point, the abnormality determining section 38 determines that the VCM driving section 32 is abnormal.

Further, determination of abnormality/normality by the abnormality determining section 38 may be executed every time a height of the waveform at a certain time point is compared by the waveform comparing section 37, or may be executed after heights of the waveform at all time points have been compared. Further, the determination may be executed when the magnetic disk apparatus 10 is activated next time.

When it is determined that the VCM driving section 32 is abnormal as a determination result of the abnormality determining section 38 or according to contents of the nonvolatile memory 39a which stores the determination result of the abnormality determining section, the controller section 20 and the control section 30 perform necessary arrangements. For example, at the time of activating the magnetic disk apparatus 10, when it is determined that the VCM driving section 32 is abnormal as a determination result of the abnormality determining section 38 or according to contents of the nonvolatile memory 39a which stores the determination result of the abnormality determining section 38, the process of moving the head 14 to a position above the magnetic disk 11 (load process) is discontinued and the abnormality of the magnetic disk apparatus 10 is notified to the host.

The storage section 39 has the nonvolatile memory 39a and a volatile memory 39b. The nonvolatile memory 39a is a rewritable memory having nonvolatile properties, and for example, made of a flash memory. The volatile memory 39b is a rewritable memory that temporarily stores a variety of information. The nonvolatile memory 39a is used for storing information which can not be lost even after power shut-off of the magnetic disk apparatus 10, such as waveform information in normal time and a determination result of the abnormality determining section 38, whereas the volatile memory 39b is used for storing information which can be lost with no trouble after power shut-off of the magnetic disk apparatus 10.

In order to reduce the cost of the magnetic disk apparatus 10, a memory which is non-rewritable but inexpensive, such as a mask ROM (Read Only Memory), can also be applied to the nonvolatile memory 39a. In this case, the nonvolatile memory 39a stores only information that does not need updating, such as the waveform information in normal time, and information that needs updating and cannot be lost after power shut-off of the magnetic disk apparatus 10, such as the determination result of the abnormality determining section 38, is stored into a prescribed region of the magnetic disk 11.

Further, among information that cannot be lost after power shut-off of the magnetic disk apparatus 10, information in a large amount of data, such as the waveform information in normal time, may be stored into the prescribed region of the magnetic disk 11, and only information in a small amount of data, such as the determination result of the abnormality determining section 38 may be stored into the nonvolatile memory 39a. This can make the storage amount of the nonvolatile memory 39a small so that the cost of the magnetic disk apparatus 10 can be reduced. In this case, the waveform information in normal time or the like which is stored in the magnetic disk 11 is developed as appropriate into the volatile memory 39b, and is used as an object for the comparison process and the like.

Here, the waveform information in normal time to be stored into the nonvolatile memory 39a or the like is information such as a result of sampling heights of a normal waveform at intervals of Δt which should be outputted by the VCM driving section 32 after the start of executing emergency unload as shown in FIG. 3.

A section 40 for clock creation by the apparatus or LSI, a section 50 for clock creation from the motor, and a switch circuit 60, which are shown in FIG. 5, are circuits to create clock signals for operations of the waveform observing section 36, the waveform comparing section 37, the abnormality determining section 38, the storage section 39, and the like. The section 40 for clock creation by the apparatus or LSI is a clock generating circuit included in the controller section 20, the control section 30 or another circuit, or is an independently provided clock generating circuit.

The section 50 for clock creation from the motor is a circuit to create a clock signal on the basis of counter-electromotive power of the SPM 12, and has Schmitt triggers and one shot pulse generator 51u, 51v and 51w, and an OR circuit 52.

The Schmitt trigger and one shot pulse generator 51u is a circuit having a hysteresis to compare a counter-electromotive voltage of a U-phase with a counter-electromotive voltage of a W-phase, the voltages being generated in the SPM 12, and outputs one-shot pulse at the moment when the counter-electromotive of the U-phase becomes larger than the counter-electromotive of the W-phase. This configuration also applies to the Schmitt triggers and one shot pulse generator 51v and 51w.

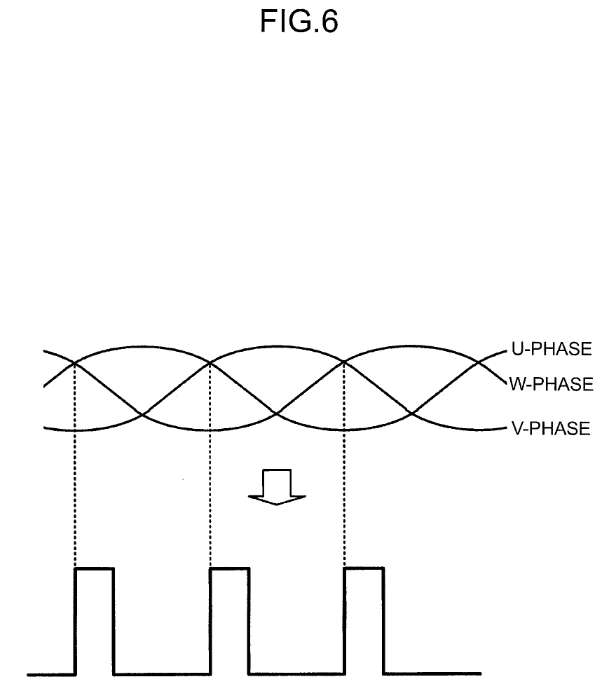

The OR circuit 52 is a circuit to superimpose pulses created by the Schmitt triggers and one shot pulse generator 51u, 51v and 51w, to be outputted as a clock signal. As shown in FIG. 6, by these circuits, a clock signal in synchronization with the start of the counter-electromotive voltage in the SPM 12 is created. As thus described, by creating a clock signal in synchronization with a waveform information of a counter-electromotive voltage generated in the SPM 12, it is possible to reliably obtain a high-quality clock.

The switch circuit 60 is a circuit to select either a clock signal supplied from the section 40 for clock creation by the apparatus or LSI or a clock signal supplied from the section 50 for clock creation from the motor, and supplies the selected signal to the waveform comparing section 37 or the like. Which clock signal is selected may be fixedly set in advance by considering a quality of a clock signal supplied from the section 40 for clock creation by the apparatus or LSI, or may be switched by dynamically determining which clock signal is of better quality.

Next, the operation of the magnetic disk apparatus 10 is described. Here, a case is described as an example where a waveform information of a signal outputted by the VCM driving section 32 at the time of executing emergency unload is previously stored into the nonvolatile memory 39a and a waveform information is verified at the time of next activation of the magnetic disk apparatus 10.

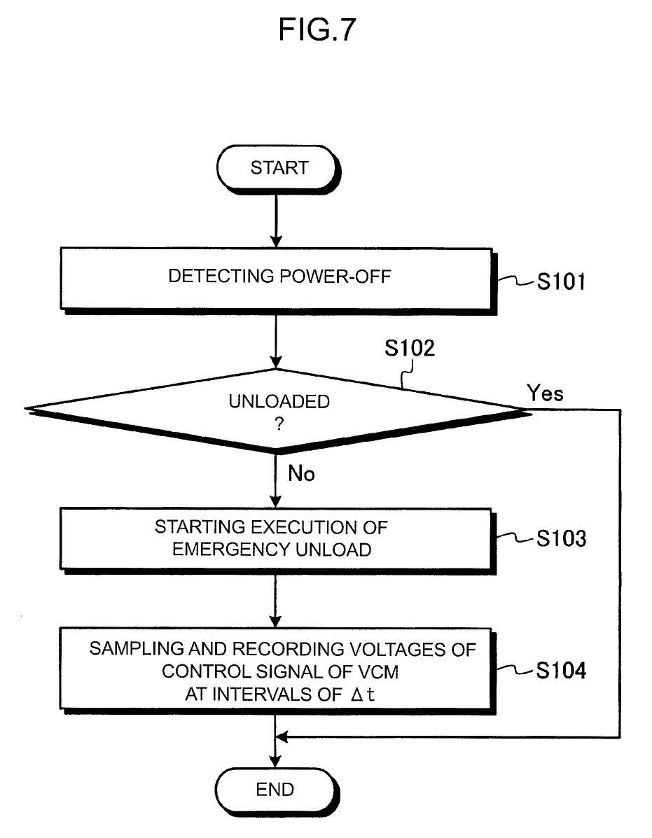

FIG. 7 is a flowchart showing an operation at the time of power-off. As shown in the figure, when the power-off is detected in the power monitoring section 34 (Step S101), the control section 30 confirms whether or not the heads 14 have already been unloaded. When the heads 14 have been unloaded (Step S102, Positive), the control section 30 performs no particular process.

On the other hand, when the heads 14 have not been unloaded (Step S102, Negative), the control section 30 instructs the VCM driving section 32 to execute emergency unload (Step S103). The control section 30 then instructs the waveform observing section 36 to observe a waveform information of a control signal of the VCM 15 which is sent out from the VCM driving section 32, and makes the result stored into the storage section 39 (Step S104).

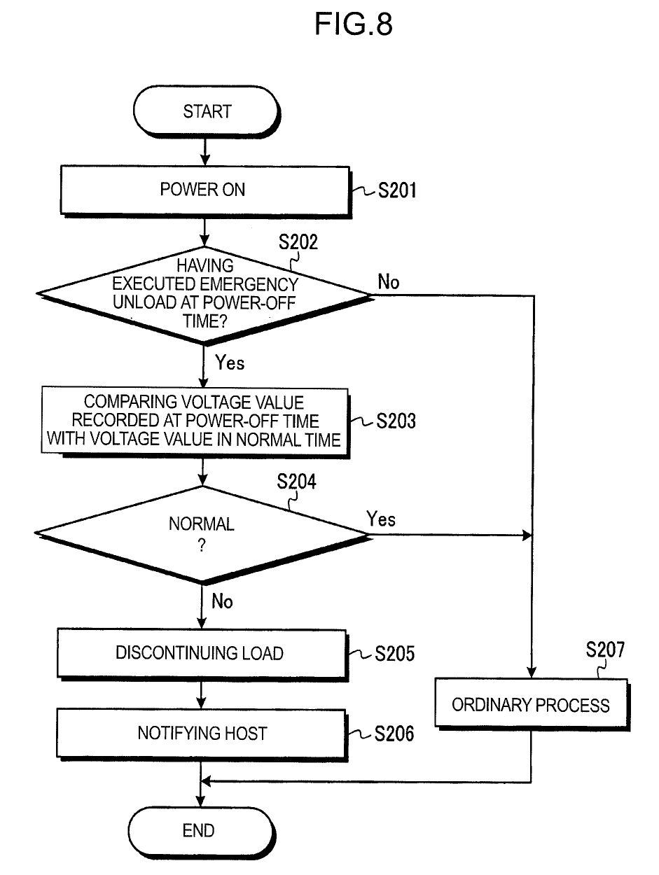

FIG. 8 is a flowchart showing an operation at the time of power-on. As shown in this figure, when power supply to the magnetic disk apparatus 10 is started (Step S201), the controller section 20 confirms whether or not emergency unload was executed at the time of previous power-off. When emergency unload was not executed (Step S202, Negative), the controller section 20 executes an ordinary activation process (Step S207).

On the other hand, when emergency unload was executed at the time of the previous power-off (Step S202, Positive), the waveform comparing section 37 compares waveform information in normal time stored in the storage section 39 with waveform information when emergency unload is executed, and the abnormality determining section 38 determines the presence or absence of abnormality of the VCM driving section 32 (Step S203). When the abnormality determining section 38 determines that the VCM driving section 32 is normal, the controller section 20 executes the ordinary activation process (Step S207).

On the other hand, when the abnormality determining section 38 determines that the VCM driving section 32 is abnormal (Step S204, Negative), the controller section and the control section 30 instruct the VCM driving section 32 to prevent the head 14 from moving to a position above the magnetic disk 11 (Step S205), and notify the host that the VCM driving section 32 is in the abnormal state (Step S206).

The configuration of the magnetic disk apparatus 10 shown in FIG. 5 can be variously changed without deviating from the gist of the disclosed technique. For example, the abnormality determining section 38 and the like may be configured to be independent of the control section 30. Further, a section for verifying the emergency unload operations of the waveform observing section 36, the waveform comparing section 37, the abnormality determining section 38 and the storage section 39, and some other sections, may be configured to be independent of the control section 30 as the emergency unload verification device.

Further, in the above example, the configuration is formed such that a waveform information of a control signal is previously stored when emergency unload is executed in normal time, and this stored waveform information is compared with a waveform information of a control signal at the time of executing emergency unload, to detect abnormality of the VCM driving section 32. However, a configuration may be formed such that an abnormal pattern of a waveform information of a control signal due to each cause of abnormality (e.g. patterns shown in FIGS. 4A and 4B) may be previously stored into the storage section 39, and these patterns are compared with a waveform information of a control signal at the time of executing emergency unload, so as to specify a cause of abnormality of the VCM driving section 32.

Moreover, a configuration may be formed such that waveforms information of control signals at the time of executing emergency unload in a plurality of generations are stored in the storage section 39 to confirm a change among the generations, and the possibility of generation of abnormality is warned against the VCM driving section 32 when a deterioration trend is observed.

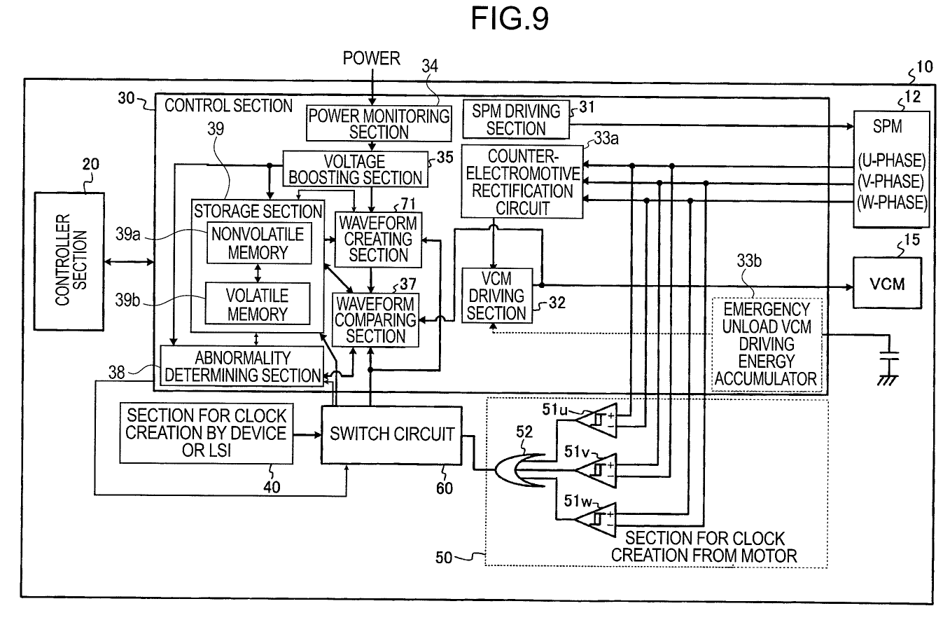

Furthermore, as shown in FIG. 9, a waveform creating section 71 may be provided in place of the waveform observing section 36. The waveform creating section 71 is a circuit to create a waveform information on the basis of the waveform information in normal time stored in the storage section 39. In this case, the waveform comparing section 37 serves as a circuit to compare a waveform information of a control signal, outputted by the VCM driving section 32 for controlling the emergency unload operation, with a waveform information created by the waveform information creating section 71 in an analog manner by combination of a comparator and an offset circuit.

As described above, in the disclosed example, since the configuration is formed such that a waveform information of a control signal sent out to the VCM driving section 32 for controlling the emergency unload operation is compared with a waveform information of a control signal in normal time which is previously stored to verify whether or not the VCM driving section 32 is abnormal, it is possible to automatically verify whether or not the VCM driving section 32 is abnormal. It is thus possible to prevent, in advance, occurrence of a critical failure in the storage apparatus so as to improve the reliability of the storage apparatus.

It is to be noted that, although the disclosed technique was described by taking the magnetic disk apparatus as an example, the disclosed technique is also applicable to other storage apparatuses such as an optical disk apparatus and a magnetic optical disk apparatus.

What is claimed is:

1. An emergency unload verification device, which verifies whether or not a control unit to control an emergency unload operation in a storage apparatus is abnormal, comprising:
a storage section which stores previous waveform information of a control signal to be sent out by said control unit for controlling the emergency unload operation;
a waveform comparing section which compares a waveform information of a control signal, sent out by said control unit for controlling the emergency unload operation when the emergency unload operation is executed, with the waveform information stored into said storage section; and
an abnormality determining section which determines whether or not said control circuit is abnormal on the basis of the comparison result of said waveform comparing section.

2. The emergency unload verification device according to claim 1, wherein said waveform comparing section compares a waveform information stored into said storage section with waveform information previously stored correspond to a cause of abnormality, to specify a cause of abnormality of said control unit.

3. The emergency unload verification device according to claim 1, wherein said waveform comparing section compares waveform information among a plurality of generations stored into said storage section, to predict generation of abnormality of said control unit.

4. The emergency unload verification device according to claim 1, the waveform information of a control signal, sent out by said control unit for controlling the emergency unload operation when the emergency unload operation is executed, recorded into said storage section, and said waveform comparing section compares the waveform information recorded into said storage section at the time of activating said storage apparatus with the waveform previously stored into said storage section.

5. The emergency unload verification device according to claim 1, wherein
said storage section stores a result of sampling heights of a waveform of a control signal at prescribed intervals which should be sent out by said control unit for controlling the emergency unload operation, as waveform information, and
said waveform comparing section compares a result of sampling heights of a waveform of a control signal at prescribed intervals, which was sent out by said control unit for controlling the emergency unload operation when the emergency unload operation is executed, with the sampling result stored into said storage section.

6. The emergency unload verification device according to claim 5, wherein said waveform comparing section compares a waveform information stored into said storage section with waveform information previously stored correspond to a cause of abnormality, to specify a cause of abnormality of said control unit.

7. The emergency unload verification device according to claim 5, wherein said waveform comparing section compares waveform information among a plurality of generations stored into said storage section, to predict generation of abnormality of said control unit.

8. The emergency unload verification device according to claim 5, wherein said storage section has the following configuration when the emergency unload operation is executed:
a waveform information of a control signal sent out by said control unit for controlling the emergency unload operation is recorded into said storage section, and a waveform information recorded into said storage section at the time of activating said storage apparatus is compared with the waveform information previously stored into said storage section.

9. The emergency unload verification device according to claim 1, wherein said waveform comparing section compares a waveform information created on the basis of the waveform information stored into said storage section with a waveform information of a control signal sent out by said control unit for controlling the emergency unload operation when the emergency unload operation is executed.

10. The emergency unload verification device according to claim 9, wherein said waveform comparing section compares a waveform information stored into said storage section with waveform information previously stored correspond to a cause of abnormality, to specify a cause of abnormality of said control unit.

11. The emergency unload verification device according to claim 9, wherein said waveform comparing section compares waveforms among a plurality of generations stored into said storage section, to predict generation of abnormality of said control unit.

12. The emergency unload verification device according to claim 9, wherein said storage section has the following configuration when the emergency unload operation is executed:
a waveform information of a control signal sent out by said control unit for controlling the emergency unload operation is recorded into said storage section, and a waveform information recorded into said storage section at the time of activating said storage apparatus is compared with the waveform information previously stored into said storage section.

13. A storage apparatus including an emergency unload function, comprising:
a driving section which sends out a control signal for executing emergency unload; and
an abnormality determining system which determines whether or not said driving section is abnormal by comparing a waveform information of control signal sent out from said driving section with a previously stored waveform information.

14. The storage apparatus according to claim 13, wherein said abnormality determining system including a waveform comparing section comparing a waveform information recorded into a storage section at the time of activating said storage apparatus with the previously stored waveform information.

15. An emergency unload verification method in which a storage apparatus verifies whether or not a driving section to send out a control signal for executing emergency unload is in an abnormal state, comprising:
a recording step of recording into a storage section a waveform information of a control signal sent out from said driving section for executing emergency unload; and
a verifying step of comparing the waveform information recorded in said recording step with a previously stored waveform information, to verify whether or not said driving section is in the abnormal state.
